(19) United States
(12) Patent Application Publication
(10) Pub. No.: US 2007/0268944 A1
(43) Pub. Date: Nov. 22, 2007

(54) Gas purification in an excimer laser using a stirling cycle cooler

(76) Inventor: Frank Voss, Bad Gandersheim (DE)

Correspondence Address: STALLMAN & POLLOCK LLP, 353 SACRAMENTO STREET, SUITE 2200, SAN FRANCISCO, CA, 94111, US

(21) Appl. No.: 11/438,203

(22) Filed: May 22, 2006

(51) Int. Cl. H01S 3/04; F25B 9/00

(52) U.S. Cl. 372/34; 62/6

(57) ABSTRACT

An excimer laser includes a laser-gas cleaning apparatus. The gas cleaning apparatus includes a cold-trap supplemented by a heat-exchanger. The cold-trap is cooled by a twin-compressor, free-piston, linear motor-driven Stirling-cycle cooler having an adjustable cooling capacity. The cold-trap, the heat-exchanger, and connecting conduits are enclosed in a housing with free space in the housing being filled with a foam insulating material.

### TECHNICAL FIELD OF THE INVENTION

The present invention relates in general to gas purification in excimer lasers. The invention relates in particular to gas purification in a cold-trap cooled by a Stirling cycle cooler.

### DISCUSSION OF BACKGROUND ART

Cryogenic cooling of excimer laser gases is a very efficient process for extending the lifetime of the laser gases and maintaining cleanliness of windows in an excimer laser chamber. In prior art cryogenic cooling arrangements laser gas is extracted from the laser chamber by a circulating pump, drawn through a heat-exchanger, then through a cryogenic cold-trap, passed back through the heat-exchanger into the laser tube.

Impurities in the gas are trapped in the cryogenic trap (cold-trap). The purified gas is passed back into the laser chamber. The purified gas in entering the laser chamber is streamed over the windows of the laser chamber which protects the windows from accumulation of dust and debris thereon while replacing contaminated gas in the chamber with purified gas. The impurities accumulate in the cold-trap. After an extended period of use, the cold-trap can be isolated from the gas circulation system and allowed to reach room temperature so the accumulated impurities can be pumped out of the cold-trap.

The temperature of the cold-trap must be selected according to the composition of the laser gas mixture such that the temperature of the cold-trap is not low enough to freeze out components of the gas mixture. By way of example, in a gas mixture for a xenon chloride (XeCl) excimer laser the cold-trap temperature must be maintained at 135° K or higher to avoid freezing (condensing) xenon (Xe) out of the gas mixture. Basically, the lower the temperature of the cold-trap the more effective the trap is at condensing contaminants, but the forgoing indicates that that this is in conflict with a need to maintain partial pressures of components of the laser gas mixture constant.

Further for a typical gas volume flow through the cold-trap, for example, about 40 Normal liters per minute, a very high cooling power (cooling capacity) would be necessary to cool the laser gas from the working temperature of about 38° C. (311°K) to 135°K by means of the cold-trap alone. This high power requirement is reduced by the heat-exchanger wherein gas being returned to the laser chamber and already cooled in the trap pre-cools gas being drawn into the trap and at the same time is heated back toward the working temperature of gas in the chamber.

In early excimer laser apparatus cold-trap cooling was effected through the use of liquid nitrogen. This presented problems in that frequent replenishment of liquid nitrogen was required and icing of components occurred. A heater was required to prevent the cold-trap temperature from falling too low.

One device commonly used for cooling cold-traps in modern excimer laser gas laser apparatus is a Gifford Mac Mahon cryostat. Such a cryostat includes a large helium (He) compressor and an associated cold-head (cold-finger). The cryostat cools the cold head to a very low temperature by repeated adiabatic expansion of helium. The cryostat seeks to reach the absolute zero point (0°K), however, because of conduction and radiation losses, even with extensive insulation, the lowest practical temperature is about 20°K. Even this temperature is far too low to avoid freezing laser gas components out of the laser gas mixture. Accordingly it is necessary, here also, to provide a heater, together with a temperature regulating circuit, to maintain the cold-trap at a practical low temperature, for example, the above-exemplified 135°K.

By way of example, using the above-discussed example of cooling gas at 40 Normal liters per minute, with deployment of an efficient heat-exchanger, a cooling capacity of about 12 Watts W would be necessary to maintain a cold-head temperature of about 135°K. A Gifford Mac Mahon cooler has a cooling capacity (power) of about 28 W at 135°K. The means that the 16 W excess cooling capacity must be countered with 16 W of heating power. This makes cooling with a Gifford Mac Mahon cooler a relatively inefficient process.

In commercial excimer laser apparatus such a cooling arrangement requires an electrical power of between about 1.8 and 2.2 kilowatts (kW). This cooling arrangement also takes up a significant space in the apparatus. Further, the compressor of the Gifford Mac Mahon cryostat, being crank driven, can create noise and vibration. Even with extensive mechanical decoupling arrangements between optical sections of the laser apparatus and the mechanical and electrical sections, this can cause vibration of optical components of the excimer laser and optical components of the beam delivery apparatus, all of which can adversely affect pointing stability of the laser-beam, which is important in most excimer laser applications.

### SUMMARY OF THE INVENTION

The present invention is directed to a gas purification apparatus for an excimer laser. In one aspect, an excimer laser in accordance with the present invention comprises a laser chamber containing a lasing gas. A heat-exchanger is in fluid communication with the laser chamber. A cold-trap is in fluid communication with the heat-exchanger. Means are provided for circulating lasing gas from the laser chamber through the heat-exchanger to the cold-trap, and from the cold-trap back through the heat-exchanger to the laser chamber. A linear-motor driven, free piston, Stirling-cycle cooler is in thermal communication with the cold-trap for cooling the cold-trap. The Stirling cycle-cooler has an adjustable cooling capacity and includes a closed loop arrangement arranged to maintain the cold-trap at a pre-determined working temperature by adjusting the cooling capacity of the Stirling-cycle cooler.

In a preferred embodiment of the present invention, the heat-exchanger and the cold-trap are surrounded by a thermally insulating material such as a polymer foam. The Stirling-cycle cooler includes first and second pistons arranged to move with a reciprocal stoke in respectively first and second cylinders. The first and second pistons are driven by respectively first and second linear motors. The first and second cylinders are in communication with a third cylinder including a third piston free to move reciprocally in the third cylinder responsive to the reciprocal motion of the first and second pistons. The cooling capacity of the Stirling cycle cooler is adjusted by varying the stroke of said first and second pistons. The first and second cylinders are horizontally opposed and the reciprocal motion of the pistons is arranged such that the first and second pistons move synchronously toward and away from each other.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 schematically illustrates a preferred embodiment of an excimer laser in accordance with the present invention, the laser including a refrigerated gas cleaning apparatus, and the gas cleaning apparatus including a cold-trap supplemented by a heat-exchanger, the heat-exchanger and cold-trap being enclosed in a heat-insulation-filled housing, and the cold-trap being cooled by a temperature-controllable twin-compressor, Stirling-cycle cooler in which the compressors are driven by linear motors.

FIG. 2 schematically illustrates details of the linear-motor driven Stirling-cycle cooler in the gas cleaning system of system of FIG. 1

FIG. 3 is a three-dimensional view schematically illustrating details of one preferred arrangement of the Stirling-cycle cooler, cold-trap, heat-exchanger, and housing of FIG. 1, with the housing shown partly cut away and with insulation removed.

FIG. 4 is a cross-section view schematically illustrating one preferred example of the cold-trap of FIG. 3.

FIG. 5 is a three-dimensional view schematically illustrating another example of a cooling system in accordance with the present invention, similar to the cooling system of FIG. 3 but wherein there are two twin-compressor, linear-motor driven, Stirling-cycle coolers.

### DETAILED DESCRIPTION OF THE INVENTION

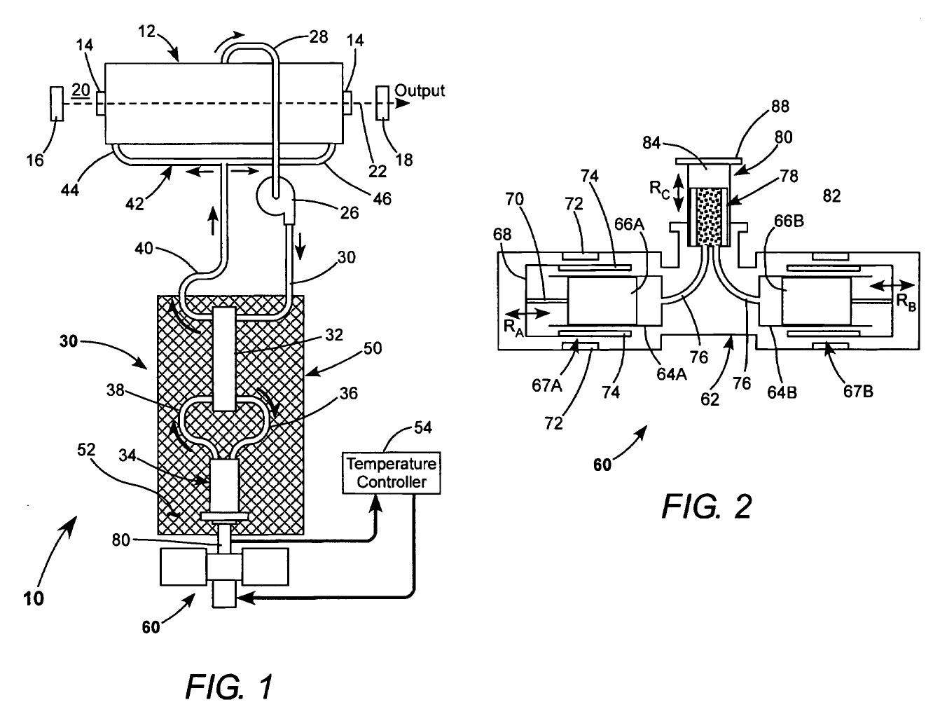

Referring now to the drawings, wherein like components are designated by like reference numerals, FIG. 1 schematically illustrates a preferred embodiment 10 of an excimer laser in accordance with the present invention. Laser 10 includes an elongated laser chamber 12 containing a lasing gas mixture. Chamber 12 has a window 14 at each end thereof. Mirrors 16 and 18 form a laser resonator 20 having a longitudinal axis 22 extending through laser chamber 12 via windows 14 therein. The laser chamber includes electrodes (not shown) for energizing the lasing gas mixture and generating laser radiation in the resonator. In this example, mirror 18 is partially transparent for the laser radiation and serves to couple laser output out of the resonator.

Those skilled in the art will recognize that this arrangement of laser chamber and resonator is a very basic arrangement, and is provided here simply for illustrating principles of the present invention. Commercial excimer lasers often include a chamber having widows arranged at Brewster angle inclination to the resonator axis, and usually include an internal circulation fan for circulating the lasing gas mixture between the electrodes. In certain commercial excimer laser arrangements, mirror 16 would be replaced by a mirror in combination with a prism or a diffraction grating for tuning the lasing wavelength of the laser and for narrowing the lasing bandwidth of the laser. A detailed description of these and other such arrangements is not necessary for understanding principles of the present invention. Accordingly such a detailed description is not presented herein. More information about excimer lasers designs can be found in the following U.S. Patents, each of which is incorporated by reference: U.S. Pat. Nos. 6,965,624; 6,557,665; 6,563,853; 6,490,307; 6,493,370; 6,727,231; 5,111,473 and 6,034,978.

Laser 10 includes a gas-cleaning (purification) apparatus 30 including a cold-trap 34 cooperative with a heat-exchanger 32 as discussed above in the description of background art. A pump 26 extracts lasing gas from chamber 12 via a conduit 28, and forces the extracted lasing gas via a conduit 30 to heat-exchanger 32. The gas leaves heat-exchanger 32 via a conduit 36 and is circulated through cold-trap 34 in which gaseous contaminants are frozen (condensed) out of the gas. Cleaned gas, at the cold-trap temperature, leaves the cold-trap via a conduit 38, which transports the cold, cleaned gas back to heat-exchanger 32. In heat-exchanger 32, the cooled gas cools incoming gas and the warm incoming gas, in turn, warms the cooled gas so that the cooled gas more closely matches temperature of the gas in laser chamber 12. Gas leaves the heat-exchanger via conduit 40 and is delivered thereby to a manifold 42. The gas flow is divided in manifold 42, with one portion thereof entering laser chamber 12 via a conduit 44 and another portion thereof entering laser chamber 12 via a conduit 46. Conduits 44 and 46 are located at extreme opposite ends of the chamber such that the cleaned gas entering the chamber can be directed over the windows as discussed above. This method of feeding gas back into chamber 12 should not be considered as limiting the present invention.

These skilled in the art will recognize that in any refrigerated gas-cleaning arrangement there may be components such as flow control valves, bypass valves, safety valves, flow meters, particle filters and the like. A description of such components is not necessary for understanding principles of the present invention. Accordingly such a detailed description is not presented herein, and such components are not shown in FIG. 1 in order to highlight important features of the present invention.

One such important feature of laser 10 is that the cold-trap and heat-exchanger are contained in a heavily insulated housing 50. In this example of cooling system 30, heavy insulation is provided by filling maximum available free-space in the housing with a foam insulating material such as a polymer or elastomer foam such that components in the housing are surrounded by the insulating material. In theory at least, an evacuated sealed-off (vacuum) housing 50 could be substituted however this presents significant practical problems. One problem is that leakage from components and connections therebetween can never be completely eliminated, and pressure in such a vacuum enclosure would eventually rise to a level where the insulating effectiveness of the enclosure would be significantly compromised. This could be overcome of course by providing a continuously vacuum pumped enclosure but this would come with a disadvantage of significantly increased cost, increased space requirement, increased power consumption and increased mechanical noise and vibration.

An essential feature of cooling system 30 is that cold-trap 34 is cooled by a linear-motor-drive, free-piston, Stirling-cycle cooler, i.e., a Stirling cycle compressor having a compressor including a piston driven by a linear motor, rather than the usual crank drive. The linear motor drive eliminates the need for a counter-heating system, which was required in prior-art refrigerated gas cleaning systems for excimer lasers to maintain a particular cold-trap temperature, and was a major contributor to the inefficiency of such systems. The reason for this is discussed below with continuing reference to FIG. 1 and with reference in addition to FIG. 2.

In cooler 60 of FIG. 2, there are two compression cylinders 64A and 64B including pistons 66A and 66B respectively. Pistons 66A and 66B are driven by linear motor (linear stepper motor) assemblies 67A and 67B respectively. Each linear motor assembly includes an anvil cylinder 68 to which the corresponding piston is connected by a piston-rod 70. Electrically driven forcer magnets 72 are mounted on the inside of the housing, and stator magnet 74 is attached to the inside of the anvil cylinder. When an AC potential is applied to the forcer magnets, the anvil cylinder and the piston attached thereto moves linearly in a reciprocal fashion as indicated by arrows RA and RB for pistons 66A and 66B respectively. The cylinders and pistons therein are horizontally opposed. The magnets are driven such that the pistons move synchronously, with the pistons moving toward then away from each other in the housing. Conduits 76 provide fluid (gaseous) communication between cylinders 64A and 64B and an expansion cylinder 80 in which there is a displacer/regenerator unit 78 (the free or free piston). Means not shown are provided for allowing the helium gas to flow around free piston 78. Free piston 78 moves reciprocally as indicated by arrows RC, out of phase with the motion of the pistons.

The Stirling cycle can be considered as beginning (the first point of the Stirling cycle) when free piston 78 is at the bottom of cylinder 80. As pistons 66A and 66B move synchronously outward, gas is drawn from expansion space 84 (the cold space) above free piston 78 and the free piston moves upward in response. When pistons 66A and 66B are at the bottom of their stroke (the second point of the Stirling cycle), free piston 78 is about midway up cylinder 80. As pistons 66A move synchronously inward in cylinders 64A and 64B, free piston 78 is driven toward the top of cylinder 80 minimizing expansion space 84 (the third point of the Stirling cycle). Further inward motion of pistons 66A and 66B to the top of their stroke drives compressed gas around the free piston into expansion space 84 where the gas expands, cools down, and forces free piston 78 back on a downward stroke (the fourth point of the Stirling cycle). The cycle is then repeated from the first point. Continual repetitions of the cycle cool the expansion end of cylinder 80 toward a minimum reachable temperature flange 88 on the expansion cylinder allows the cylinder to be clamped in thermal communication with the cold-trap for cooling the cold-trap. Heat generated by the compression of gas by pistons 66A and 66B can be removed from the housing by attaching fins (not shown in FIG. 2) to the housing, by surrounding all or portions of the housing with a cooling-water jacket (also not shown), or both.

In cooler 60, the distance traveled by pistons 66A and 66B, and accordingly the degree of gas compression in corresponding cylinders 64A and 64B, is determined by the magnitude of the AC current supplied to forcer magnets 72 in the linear drive units. A closed-loop temperature controller can be arranged to maintain the expansion cylinder at a desired temperature, greater than the lowest temperature achievable by the cooler, by sensing the expansion cylinder temperature and adjusting the stroke (travel) of the pistons, and correspondingly the cooling capacity of the cooler, to be only sufficient to achieve the desired cooler temperature. It is this feature of cooler 60 that eliminates the need for the heater that is necessary in prior-art cooler arrangements to overcome the maximum cooling capacity of the cooler and prevent the cooler from reaching the ultimate low temperature thereof.

Regarding eliminating noise, the linear drive motors in cooler 60 are inherently quieter than crank-driven coolers that deployed in prior-art excimer laser gas cleaning systems. A particular advantage of having two pistons horizontally is that the pistons can be reciprocally driven synchronously toward and away from each other, as described above, such that the inertia one piston cancels the inertia of the other. This is minimizes noise and vibration in the cooler. Another advantage of course is that the two pistons provide greater cooling capacity than that which would be provided by a single cylinder.

It should be noted, here, that only sufficient description of cooler 60 is provided to illustrate how such a cooler eliminates the need for the heater and reduces operational noise and vibration. Twin compressor, free piston, Stirling cycle coolers of the type depicted schematically in FIG. 2 are available from RICOR Cryogenic and Vacuum Systems, of En Harod Ihud, Israel, as Model No. K535. These are available in a water-cooled versions. The water-cooled version is available supplemented by air-cooling.

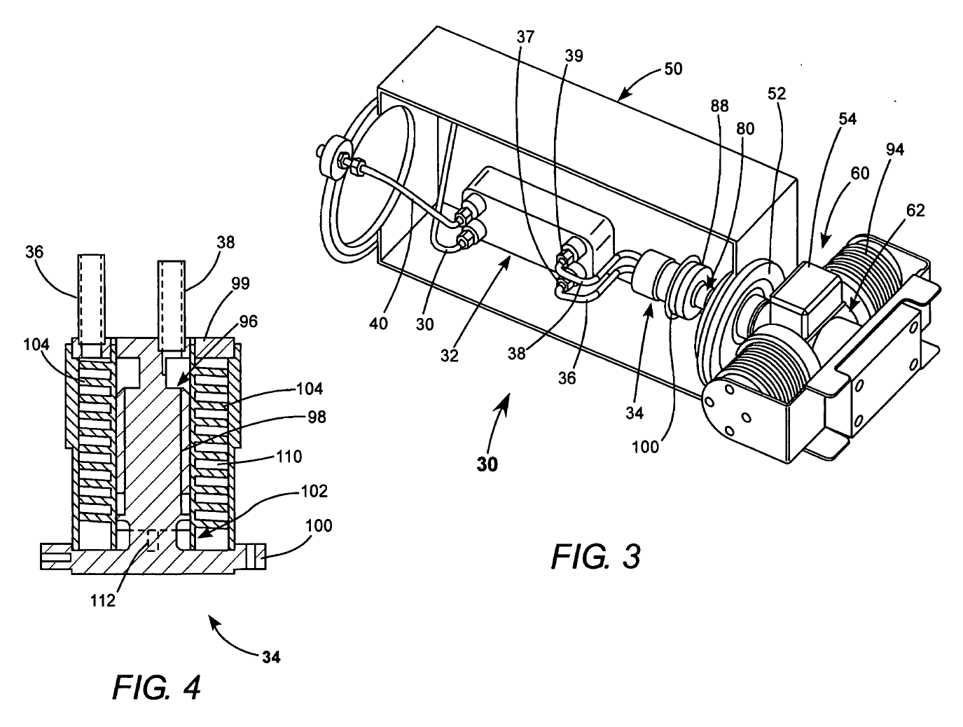

FIG. 3 is a three-dimensional view schematically illustrating further details of one preferred arrangement of cooling apparatus 30 of FIG. 1. Components of the apparatus are designated by the same reference numerals used in the more schematic two-dimensional representations of FIGS. 1 and 2. Housing 50 is cut-away and foam insulation removed therefrom to expose components therein. A feedthrough flange 52 is provided in housing 50 for connecting cooler 60 to cold trap 34 in the housing.

In FIG. 3, the cooler depicted is representative of the above-discussed RICOR Model K535, with both air cooling and water cooling provisions. Water cooling is provided by a cooling tube 94 coiled around the cylinders, water-cooling connections are under the cooler an accordingly are not visible. Heat-exchanger 32 is representative of a Model B5 heat-exchanger, available from SWEP International, of Landskrona, Sweden.

A preferred configuration of cold-trap 34 is depicted in FIG. 4. Here, cold-trap 34 is a special construction manufactured by Lambda Physik AG, of Göttingen, Germany, the assignee of the present invention. This preferred configuration of cold-trap 34 comprises a core member 96 having a helical rib 98 extending therealong, a plug 99 on a proximal end thereof, and a flange 100 on a distal end thereof. Flange 100 is configured for coupling to flange 84 of the cooler, via an indium (In) gasket or the like. Core member 96 is surrounded by an inner cylinder 102 having a helical rib 104 extending therearound. Cylinder 102 is surrounded by an outer cylinder 106 which is brazed and sealed to the flange and the plug of core member 96. Conduits 36 and 38, only a short section of which is depicted in FIG. 4 for convenience of illustration, are brazed and sealed into to the plug. Opposite ends of the conduits are attached to heat-exchanger 32 via Swagelock® fittings 37 and 39 respectively (see FIG. 3). A helium leak rate as low as 10⁻⁸ millibar liters per second (mbar l/s) was achieved with this arrangement.

Gas enters cold-trap 34 via conduit 36 and flows in a spiral fashion around a helical channel 110 formed by helical rib 104 of cylinder 102 and the inner wall of outer cylinder 106, progressing from top to bottom of the cold-trap. Gas enters the inside of cylinder 102 via a slit 112 therein at the bottom thereof (depicted in phantom in FIG. 4). Gas then flows upward between ribs 98 of core member 86 and exits the cold-trap via conduit 38.

In an experiment to evaluate the effectiveness of the inventive cooling arrangement a Leybold, Gifford Mac Mahon cooler based cooling apparatus was removed from a Model LS 2000, XeCl, Excimer Laser made by Lambda Physik AG and was replaced with an example of the inventive cooling system 30, described above with particular reference to FIGS. 3 and 4. Gas flow through the cooling systems in each case was about 38.4 Normal liters per minute. The inventive cooling apparatus was equally as effective in gas cleaning and maintaining cleanliness of the laser chamber windows as the Gifford Mac Mahon cooled apparatus. The laser delivered over 700 million laser pulses and operated over a period of three months without any indication of failure of the inventive cooling apparatus.

The RICOR K535 cooler required a maximum (initial) power input of only about 200 W which fell to less than about 100 W once the cold-trap working-temperature of about 135 K was reached. A temperature of about 150K was reached in about 100 minutes. The working temperature of 135K was reached in about 170 minutes. This about three times as long as was required by the Gifford Mac Mahon cooler. However, as gas cleaning systems in commercial excimer lasers are normally operated continuously, this longer cool-down time is an insignificant disadvantage, particularly when compared with a substantial energy and space savings in the inventive apparatus. By way of example, the replaced Gifford Mac Mahon cooler required an initial power input of about 1.8 and 2.2 kW falling to about 1.4 kW once the working temperature was reached. This is about 14 times the power required by the inventive cooling arrangement. Space occupied by the inventive cooling apparatus is only about 420 mm×430 mm×520 mm.

Improvements in efficiency of the inventive cooling apparatus may be achieved by improvement of heat-insulation or cooling of components. One possible such improvement would to provide active supplemental cooling, such as a water-cooling jacket, around the expansion cylinder of cooler 60, this could be connected in series with the cooling jacket of the cooler itself. Another possible improvement would be to provide a water cooling tube around feedthrough flange 52 of insulating housing 50 of the cooler.

One means of improving thermal insulation would be to increase the volume of housing 50 and the insulating foam therein. The extent to which this is possible would be determined by space available in the laser.

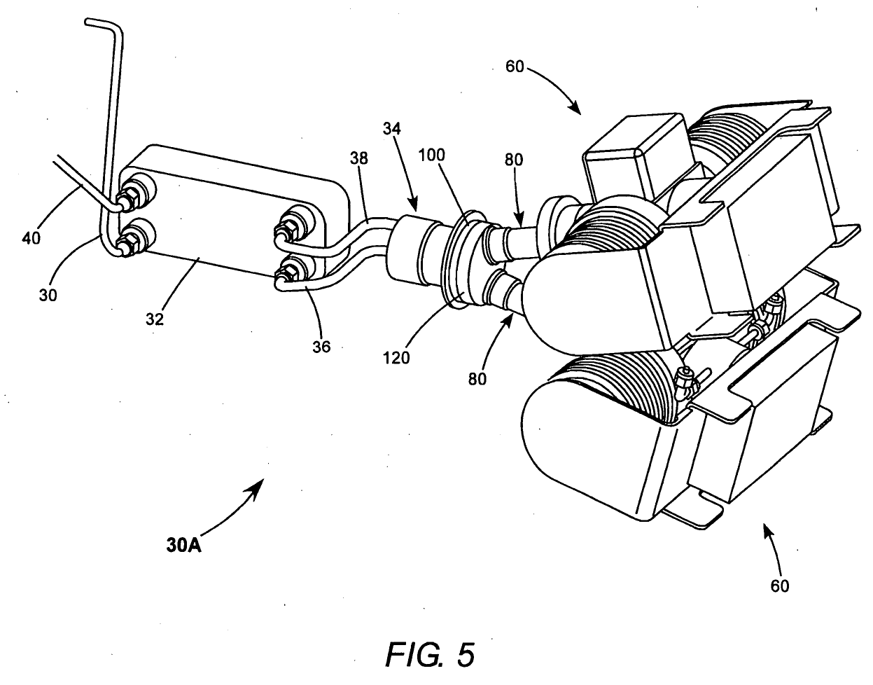

One means of increasing cooling power in the inventive cooling system would be to thermally couple two or more free-piston Stirling-cycle coolers to cold-trap 34. One embodiment 30A of such an arrangement is depicted in three dimensions in FIG. 5. Here, the inventive cooling system includes two twin-compressor, free-piston, Stirling-cycle coolers 60, arranged with bases thereof facing each other, such that expansion cylinders 80 thereof are at an acute angle to each other. An adapter 120 connects the two expansion cylinders 80 to flange 100 of cold-trap 34.

In summary, the present invention is described above in terms of a preferred and other embodiments. The invention is not limited, however, to the embodiments described and depicted. Rather the invention is limited only by the claims appended hereto.

What is claimed is:

1. An excimer laser, comprising:
a laser chamber containing a lasing gas;
a heat-exchanger in fluid communication with said laser chamber;
a cold-trap in fluid communication with said heat-exchanger;
means for circulating lasing gas from said laser chamber through said heat-exchanger to said cold-trap, and from said cold-trap back through said heat-exchanger to said laser chamber;
a Stirling-cycle cooler in thermal communication with said cold-trap for cooling said cold-trap, said Stirling cycle-cooler having an adjustable cooling capacity; and
wherein said Stirling-cycle cooler includes a closed loop arrangement arranged to maintain said cold-trap at a pre-determined working temperature by adjusting the cooling capacity of said Stirling-cycle cooler.

2. The laser of claim 1, wherein said heat-exchanger and said cold-trap are surrounded by a thermally insulating material.

3. The laser of claim 2, wherein said thermally insulating material is one of a polymer-foam and an elastomer-foam.

4. The laser of claim 1, wherein said Stirling-cycle cooled is a linear-motor driven, free piston cooler.

5. The laser of claim 4, wherein said Stirling-cycle cooler includes first and second pistons arranged to move with a reciprocal stoke in respectively first and second cylinders, said first and second pistons being driven by respectively first and second linear motors, said first and second cylinders being in communication with a third cylinder including a third piston free to move reciprocally in said third cylinder responsive to said reciprocal motion of said first and second pistons.

6. The laser of claim 5, wherein said cooling capacity of said Stirling cycle cooler is adjusted by varying the stroke of said first and second pistons.

7. The laser of claim 5, wherein said first and second cylinders are horizontally opposed and said reciprocal motion of said pistons is arranged such that said first and second pistons move synchronously toward and away from each other.

8. An excimer laser, comprising:
a laser chamber containing a lasing gas;
a heat-exchanger in fluid communication with said laser chamber and a cold-trap in fluid communication with said heat-exchanger said heat-exchanger and said cold-trap being located in a housing and surrounded by a thermally insulating material;
means for circulating lasing gas from said laser chamber through said heat-exchanger to said cold-trap, and from said cold-trap back through said heat-exchanger to said laser chamber;
a linear-motor driven, free piston, Stirling-cycle cooler in thermal communication with said cold-trap for cooling said cold-trap, said Stirling cycle-cooler having an adjustable cooling capacity, and including first and second pistons arranged to move with a reciprocal stoke, in respectively first and second horizontally opposed cylinders, synchronously toward and away from each other, said first and second pistons being driven by respectively first and second linear motors, and said first and second cylinders being in communication with a third cylinder including a third piston free to move reciprocally in said third cylinder responsive to said reciprocal motion of said first and second pistons; and
wherein said Stirling-cycle cooler includes a closed loop arrangement arranged to maintain said cold-trap at a pre-determined working temperature by adjusting the cooling capacity of said Stirling-cycle cooler.

9. The laser of claim 8, wherein said cooling capacity of said Stirling cycle cooler is adjusted by varying the stroke of said first and second pistons.

10. The laser of claim 8, wherein said thermally insulating material is one of a polymer-foam and an elastomer-foam.

11. The laser of claim 8, wherein said heat exchanger is configured and arranged such that lasing gas from said laser chamber passing therethrough is pre-cooled by cooled lasing gas leaving said cold trap.

12. The laser of claim 8, further including a second linear-motor driven, free piston, Stirling-cycle cooler in thermal communication with said cold-trap for cooling said cold-trap, said second Stirling cycle-cooler having an adjustable cooling capacity, and including first and second pistons arranged to move with a reciprocal stoke, in respectively first and second horizontally opposed cylinders, synchronously toward and away from each other, said first and second pistons being driven by respectively first and second linear motors, and said first and second cylinders being in communication with a third cylinder including a third piston free to move reciprocally in said third cylinder responsive to said reciprocal motion of said first and second pistons.

13. An excimer laser, comprising:
a laser chamber containing a lasing gas;
a heat-exchanger in fluid communication with said laser chamber;
a cold-trap in fluid communication with said heat-exchanger;
means for circulating lasing gas from said laser chamber through said heat-exchanger to said cold-trap, and from said cold-trap back through said heat-exchanger to said laser chamber;
a cooler in thermal communication with said cold-trap for cooling said cold-trap, said cooler having an adjustable cooling capacity; and
wherein said cycle cooler includes a closed loop arrangement arranged to maintain said cold-trap at a pre-determined working temperature by adjusting the cooling capacity of said cooler.
